(19) United States
(12) Patent Application Publication
(10) Pub. No.: US 2014/0205397 A1
(43) Pub. Date: Jul. 24, 2014

(54) System and Method for Providing a Photobook

(71) Applicant: DOT COPY, INC., Chatsworth, CA (US)

(72) Inventors: William Giamela, Chatsworth, CA (US); Brian Whiteman, Chatsworth, CA (US)

(73) Assignee: DOT COPY, INC., Chatsworth, CA (US)

(21) Appl. No.: 14/160,503

(22) Filed: Jan. 21, 2014

Related U.S. Application Data
(60) Provisional application No. 61/754,531, filed on Jan. 19, 2013.

(51) Int. Cl. B42C 19/00; B42D 1/08

(52) U.S. Cl. CPC B42C 19/00; B42D 1/08
USPC 412/6; 281/21.1; 412/13

(57) ABSTRACT

The present disclosure provides a photobook including a plurality of pages including a plurality of printed images, and a bound edge that binds an edge of each of the plurality of pages, wherein the bound edge includes at least one recessed void along its length, wherein the recessed void increases the flexibility of the bound edge. The disclosure also provides a system and method of making the photobook provided herein.

### CROSS-REFERENCE TO RELATED APPLICATIONS

This application incorporates by reference and claims priority benefit to U.S. Provisional Application 61/754,531, filed on Jan. 19, 2013.

### BACKGROUND OF THE INVENTION

The present subject matter relates generally to a photobook. More specifically, the present invention is a system and method for providing a printed photobook compiled in a particular manner from photos on a mobile device that enables efficient and cost-effective shipping of the photobook.

Photographs are important for a variety of reasons. Some are historical portals that reflect a state of the world during the period in which the photo was captured. Others are expressions of art that may invoke emotion or convey a statement. Photos also sustain memories, acting as stimulants that summon stories from a viewer's past. Accordingly, the significance of imagery preservation in human cultures underlies the profound popularity of photography, and in particular, modern digital photography.

The proliferation of digital photography is fueled by advances in digital imaging technology, such as that provided in digital cameras, camera phones, and tablet computers. Each of these devices is highly portable, and users may easily transfer captured images to a computer, a cloud based memory system, or other storage media. Consequently, users continue to capture an escalating number of digital images, which serves to escalate the importance of suitable means to organize and view the images.

Some users employ a computer to organize digital images and share them with others. However, the prospect of archiving vast quantities of digital images into meaningful subsets often confounds users, sometimes paralyzing intentions to share or print even a single image. Additionally, this method of computerized photo sharing diminishes the tactile enjoyment derived from handling paper photos and is otherwise dramatically different from the traditional method of sharing printed photos in a book. Equally problematic are the expenses of in home photo printing and the inconvenience of photo lab printing.

Several means of printed photobook creation have been proposed. Anderson U.S. Pat. No. 7,376,290 discloses a method and system for providing a user with access to a printed photobook, wherein the user is allowed to set a plurality of defaults for configuring the album. Although Anderson describes a means to archive images in a customized manner, it proposes to do so without relieving users of the periodic and time-consuming choices required to facilitate album production. Additionally, Peters U.S. Pub. No. 2011/0123124 proposes to diminish creative consternation by providing an automated means for photobook generation, wherein images are clustered according to predetermined image characteristics. However, like Anderson, Peters does not provide a means to remediate the high cost and inconvenience associated with photobook printing and shipping.

Several web-based photo sharing and photo printing services, including Snapfish (see http://www.snapfish.com/), Picasa (see http://picasa.google.com), and Shutterfly (see http://www.shutterfly.com/), provide consumers with access to online photobook editing tools, good quality prints, and the convenience of mail ordering. However, these services still require users to archive their photos, organize their albums, and upload each album to a hosted memory system before ordering may occur. Additionally, the printed photobooks produced by these services, particularly when combined with shipping and handling fees, remain cost prohibitive purchases for millions of consumers.

In addition, advertisers are always looking for unique opportunities to place their advertisements in front of consumers. Direct mailing has traditionally been a method of getting ads into the hands of consumers, but it often falls short of attracting the attention the advertiser desires. Any opportunity to place advertisements into a position in which the user will interact with the ad can be attractive to advertisers.

As shown, printed photobook production remains an inconvenient, time consuming, and expensive endeavor using known technology. Accordingly, there is a need for a system and method adapted to provide a convenient and cost effective means for providing printed photobooks. Additionally, there is a need for new mechanisms for delivering direct mailed ads to consumers.

### BRIEF SUMMARY OF THE INVENTION

To meet the needs described above, the present invention provides a printed photobook compiled from digital photos. The photobook is designed through a software application, utilizes a unique flexible binding structure, and provides valuable advertising context and opportunities.

In a preferred embodiment, the present invention allows a user of a software application on a mobile device to purchase printed photobooks. The software application may be installed on any suitable electronic mobile device, such as a smart phone or tablet computer; however, it is understood that the application may be provided though any computing device, including laptop and desktop computers, as well as through services provided online. On a monthly basis, the software application collects a set of one hundred photos from the mobile device, uploads the photos to a remote server, and causes the photos to be printed into an album. The album is a book comprised of these printed photos, the book having semicircle void carved from its bound edge. The semicircle void enables the book to be shipped as bulk mail under current USPS rules. One may not ship bulk mail with a stiff bound edge; the semicircle void makes the bound edge of the album flexible enough to pass bulk-mailing requirements (see https://www.usps.com/). The finished photobook is then mailed to the user.

The interior pages of the album may have perforated edges for easy removal of the photos. Further, in some embodiments, tear out ads and/or coupons may be inserted within the album between photos. By interspersing the ads between personal photos, the user may be much more likely to engage with the ads and coupons, particularly when the specific ordering of the photos and ads is not immediately recognizable to the user. A randomized ordering of photos to ads may be the most likely manner to get users to see the ads.

In some embodiments, the user may optionally use the software to individually select the one hundred photos for printing or allow the software to select the one hundred most recently captured photos by default. In other embodiments, the user may optionally select duplicate quantities of photos for printing in the album. In still further embodiments, the user may cause third parties to receive supplemental copies of the finished photobook by mail. These processes may be accomplished through a user interface provided by the mobile application. Of course, the number of photographs compiled in the photobook may vary from application to application. It is understood that the benefits of the subject matter provided herein can be realized whether the photobook includes a lesser or greater number of photos.

An example of a system for providing a photobook includes: (1) a software application; (2) a mobile device adapted to: execute the software application; provide a user interface through the software application; access stored digital images; and communicate with a remote server; (3) a remote server adapted to receive digital images from the mobile device; (4) a printer for printing digital images received by the remote server; (5) a bookbinding machine adapted to provide photobooks having flexible bound edges; and (6) a bulk mail service. The software application may include a mechanism for individually selecting photos (specific images and/or quantities thereof). The bookbinding machine may include a mechanism for perforating the photo edges. Further, the printer may include a mechanism for providing ads or coupons inserted between the photos in the album.

A method for providing a photobook may include the steps of: installation of a software application on a mobile device; capturing or otherwise providing digital images to the mobile device; selecting digital images for upload to a remote server; periodic transmission of digital images to the remote server; printing and binding of digital images in a photobook having a flexible bound edge; and shipping photobooks using a bulk mail service. The method may further include the step of individually selecting photos (specific images and/or quantities thereof) for upload to the remote server. The method may further include the step of perforating the printed photo edges. The method may further include the step of providing tear out ads or coupons inserted between the photos in the album.

In an embodiment, the photobook comprises a plurality of pages including a plurality of printed images, and a bound edge that binds an edge of each of the plurality of pages, wherein the bound edge includes at least one recessed void along its length, wherein the recessed void increases the flexibility of the bound edge. In an example, the recessed void is a semicircle void. The recessed void enables the photobook to qualify to be shipped as bulk mail under USPS regulations.

The photobook may include one or more pages including one or more advertisements interspersed between the plurality of pages. The plurality of pages may include a perforation extending parallel to the bound edge, wherein tearing along the perforation of one of the plurality of pages separates the page from the photobook. In one example of the photobook, the plurality of pages includes a time stamp located between the bound edge and the perforation.

The present disclosure also provides for a system for providing a photobook, the system comprising a mobile device comprising a software application and stored digital images, a remote server in communication with the mobile device, and a bookbinding machine in communication with the remote server. The software application is configured to access the stored digital images, receive selected stored images, and periodically send the selected stored images to the remote server. The bookbinding machine is configured to access the selected stored images from the remote server, and wherein the bookbinding machine produces a photobook of printed selected stored images on a plurality of pages. The photobook includes a bound edge that binds an edge of each of the plurality of pages, wherein the bound edge includes at least one recessed void along its length, wherein the recessed void increases the flexibility of the bound edge.

In an example, the step of “receiving selected stored images” includes the software application periodically selecting images from a plurality of stored images within the mobile device. In another example, the step of “receiving selected stored images” includes receiving selecting images from a user via a user interface, wherein the selected stored images are selected from a plurality of stored images within the mobile device.

The present disclosure also provides for a method of providing a photobook, wherein the method includes accessing a plurality of digital images stored in a mobile device, wherein the mobile device is in communication with a remote server, selecting a portion of the plurality of digital images, and periodically transmitting the selected digital images to the remote server in communication with a bookbinding machine. The bookbinding machine is configured to print the selected digital images and bind the printed selected digital images in a photobook, wherein the photobook includes a bound edge including at least one recessed void along its length, wherein the recessed void increases the flexibility of the bound edge. In an example, the method further includes the step of shipping the photobook using a bulk mail service.

The present disclosure also provides for a bookbinding system including a software application configured to access stored digital images within a mobile device, wherein the software application periodically selects a portion of the stored digital images for transmission to a bookbinding machine. The bookbinding machine prints and binds the selected stored digital images into a photobook, wherein the photobook includes a bound edge including at least one recessed void along its length, wherein the recessed void increases the flexibility of the bound edge.

Many of these examples describe the systems and methods with respect to photos received through a mobile device. However, as noted above, the photos may be received from any computer system.

The disclosure provides for a bookbinding system that includes a bookbinding machine configured to receive selected digital images, print the selected digital images, and bind the selected digital images into a photobook. The photobook includes a bound edge including at least one recessed void along its length, wherein the recessed void increases the flexibility of the bound edge.

In an example, the recessed void is a semicircle void located approximately at the midpoint of the length of the bound edge. In another example, the recessed void enables the photobook to qualify to be shipped as bulk mail under USPS regulations.

The disclosure also provides a bookbinding method including receiving selected digital images, printing the selected digital images, and binding the selected digital images into a photobook. The photobook includes a bound edge including at least one recessed void along its length, wherein the recessed void increases the flexibility of the bound edge. In an example, the recessed void is a semicircle void located approximately at the midpoint of the length of the flexible bound edge. In another example, the recessed void enables the photobook to qualify to be shipped as bulk mail under USPS regulations.

An advantage of the present invention is that it provides mobile device users with a simple and convenient means to produce printed photobooks comprised of their captured digital photos.

Another advantage of the present invention is that it provides mobile device users with a low cost and convenient means for timely receiving printed photobooks comprised of their captured digital photos.

Yet another advantage of the present invention is that it provides merchants with a simple and cost effective means to increase the visibility of ads and coupons among targeted customers.

Additional objects, advantages, and novel features of the examples will be set forth in part in the description which follows, and in part will become apparent to those skilled in the art upon examination of the following description and the accompanying drawings or may be learned by production or operation of the examples.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram illustrating a system for providing a photobook.

FIG. 2 is a flow chart illustrating a method for providing a photobook.

FIG. 3A is a flowchart comprised of software interface screenshots indicating optional features for individual photo selection or removal by a user.

FIG. 3B is flowchart comprised of software interface screenshots indicating optional features for individual photo volume designation by a user.

FIGS. 4A and 4B are both images of the photobook of the present invention captured at alternative angles intended to accurately display the semicircle void carved from the bound edge of the photobook.

FIGS. 4C and 4D are both images of the photobook of the present invention laid open to display the flexibility of the bound edge of the photobook.

FIGS. 5A and 5B are top views of examples of pages of the photobook including a perforation.

### DETAILED DESCRIPTION OF THE INVENTION

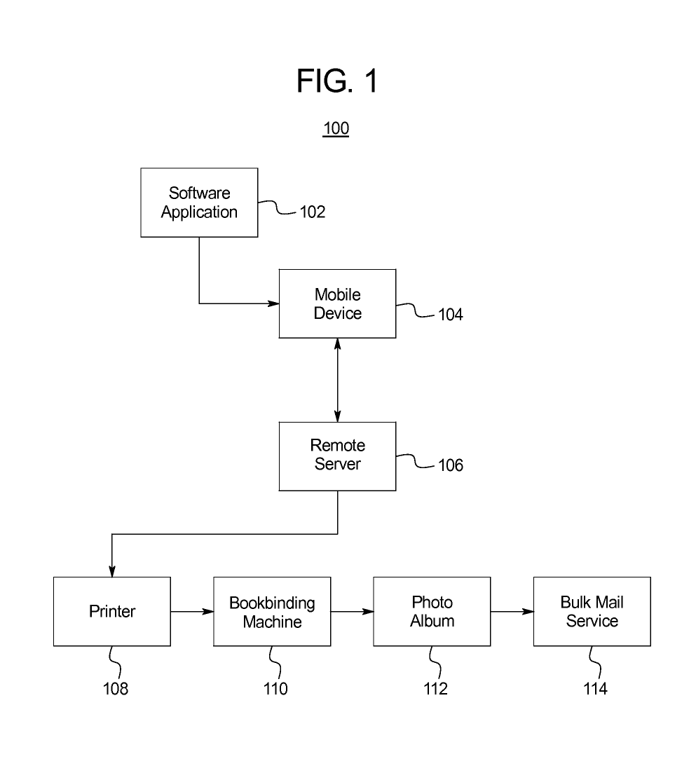

FIG. 1 is a block diagram that illustrates a system 100 for providing a photobook in accordance with the present invention. As shown in FIG. 1, the system includes: a software application 102; a mobile device 104; a remote server 106; a printer 108; a bookbinding machine 110; a photobook 112; and a bulk mail service 114.

In the example shown in FIG. 1, the system for providing a photobook 100 includes: a software application 102; a mobile device 104 adapted to: execute the software application 102; provide a user interface; access stored digital images 408; and communicate with a remote server 106; the remote server 106 is adapted to receive digital images 408 from the mobile device 104; a printer 108 for printing digital images 408 received by the remote server 106; a bookbinding machine 110 adapted to provide a photobook 112 having a flexible bound edge 404; and a bulk mail service 114, such as the United States Postal Service (“USPS”), which delivers the photobook 112 to the user. The remote server 106 may be part of the bookbinding machine 110.

As used herein, the term software application 102 describes any software application capable of: (a) accessing and displaying stored digital images 408 via a user interface, (b) alternatively, either selecting a default set of stored digital images 408 for transmittal to a remote server 106, or allowing a user to select a set of stored digital images 408 for transmittal to a remote server 106, and (c) triggering the transmission of the set of digital images 408 to the remote server 106 on a periodic or one-time basis.

While the primary embodiments described herein involve a mobile device 104, it is contemplated that the systems 100 and methods 200 described herein may incorporate any computing device in communication with the remote server 106. For example, the selected digital images 408 transmitted to the remote server 106 may be accessed through a desktop or laptop computer, having been imported from a mobile device 104, a digital camera, or other electronic device, or resident in an associated data storage device, whether local or in the cloud.

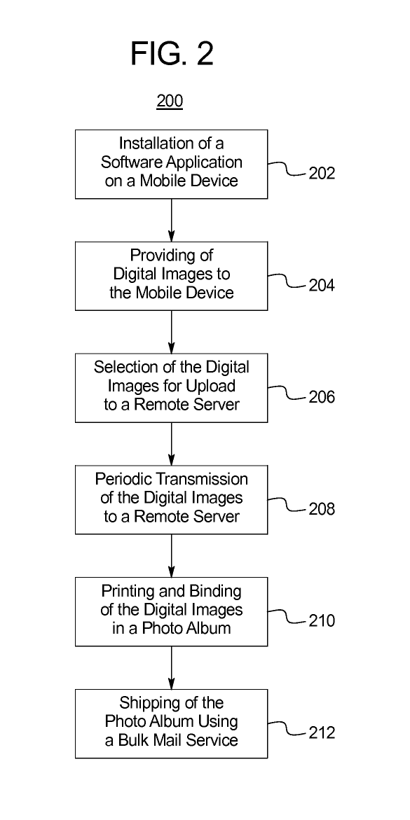

FIG. 2 illustrates a method 200 for implementing a system for providing a photobook. As shown in FIG. 2, the method 200 includes the steps of: installing a software application 102 on a mobile device 104; providing digital images 408 to the mobile device 104; selecting digital images 408 for upload to a remote server 106; periodic transmission of digital images 408 to a remote server 106; printing and binding of digital images 408 in a photobook 112 having a flexible bound edge 404; and shipping a photobook 112 using a bulk mail service 114.

The flowchart of FIG. 2 at step 202 indicates that a user may install a software application 102 on a mobile device 104, such as a smart phone or tablet computer. It is contemplated, however, that the mobile device 104 may be any electronic device capable of transmitting, receiving, processing, and/or displaying multimedia known to one having ordinary skill in the art. Once the software application 102 has been installed on the mobile device 104, the user may subsequently use a provided software interface to purchase a photobook 112. In a preferred embodiment, the photobook 112 or a portion of the photobook may be free, requiring the user to pay only a shipping and processing fee.

The flowchart of FIG. 2 at step 204 indicates that a user may provide digital images 408 to the mobile device 104. In a preferred embodiment, the user may capture digital images 408 for storage in a local data repository of the mobile device 104. However, it is contemplated that the digital images 408 may be alternatively stored on a removable memory medium, such as a flash drive, or a remote (hosted) memory medium. Additionally, one of ordinary skill in the art will recognize that the present invention will operate effectively for digital images 408 that either were not originally captured on the mobile device 104 or were captured prior to installation of the software application 102.

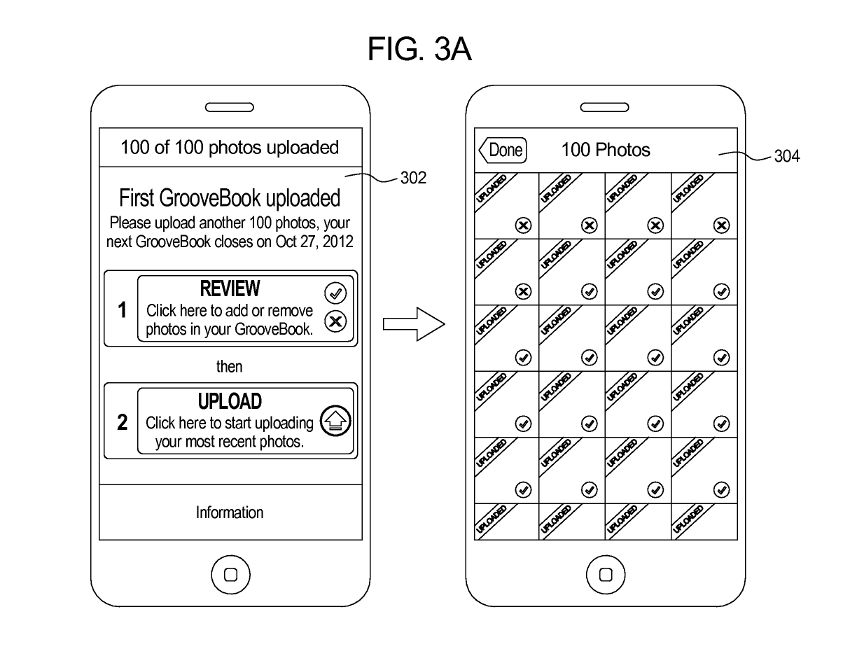

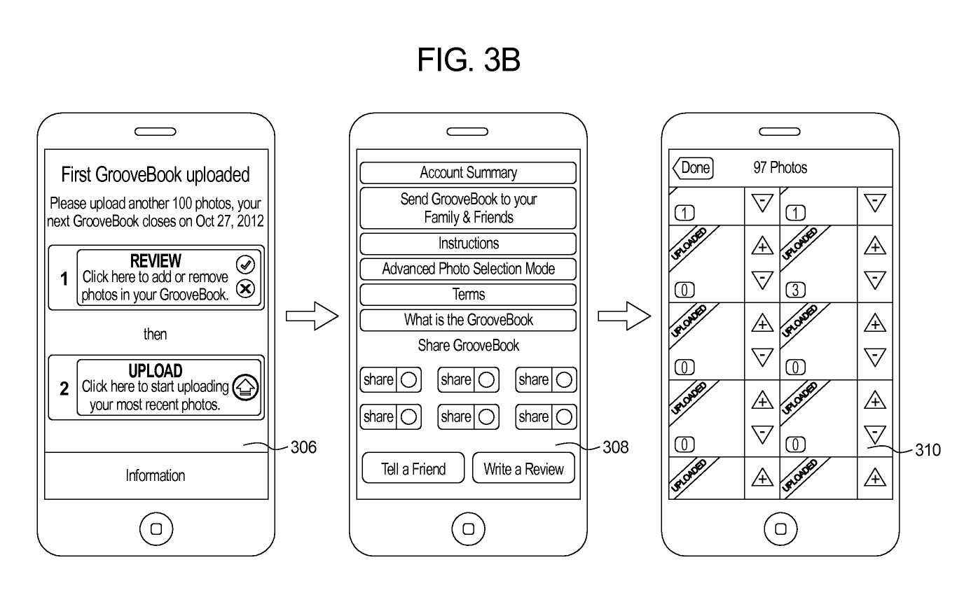

The flowchart of FIG. 2 at step 206 indicates that a user may optionally select which digital images 408 are placed in a queue for uploading to the remote server 106 (see FIGS. 3A-B). Alternatively, by default the software application 102 of the present invention may cause the queue to be comprised of the one hundred most recently captured digital images 408 stored in the data repository of the mobile device 104. In a preferred embodiment, one hundred digital images 408 may be placed in the queue. Of course, the default number of digital images 408 may be any number, one hundred is just one example.

The flowchart of FIG. 2 at step 208 indicates that a user may upload the designated queue of digital images 408 from the mobile device 104 to a vendor accessible remote server 106 on a monthly basis for the purpose of receiving a photobook 112. In a preferred embodiment, a wireless network to which both the mobile device 104 and remote server 106 are connected may facilitate the upload process. It is contemplated, however, that the upload process may be facilitated by any suitable data connection method known to one having ordinary skill in the art. In some embodiments, the vendor is a photobook vendor. In other embodiments, the user selects intended third party recipients of copies of the photobook 112. Further, in other embodiments, the software application 102 may automatically trigger the uploading of a default set of digital images 408 to the remote server 106 on a periodic basis. In yet other embodiments, the monthly uploading interval may vary based on user preferences or may be a one-time or ad hoc process.

In an example, the method 200 includes selecting a portion of the plurality of digital images 408, and periodically transmitting the selected digital images 408 to the remote server 106 in communication with a bookbinding machine 110. As described above, the plurality of digital images 408 may be selected by the user or automatically by the software application 102. Further the selection may occur in periods based on time, such as every week or month, or based on a number of taken digital images 408. For example, the software application 102 may upload a selection of digital images 408 every time the user's mobile device 104 acquires, for example, fifty new digital images 408.

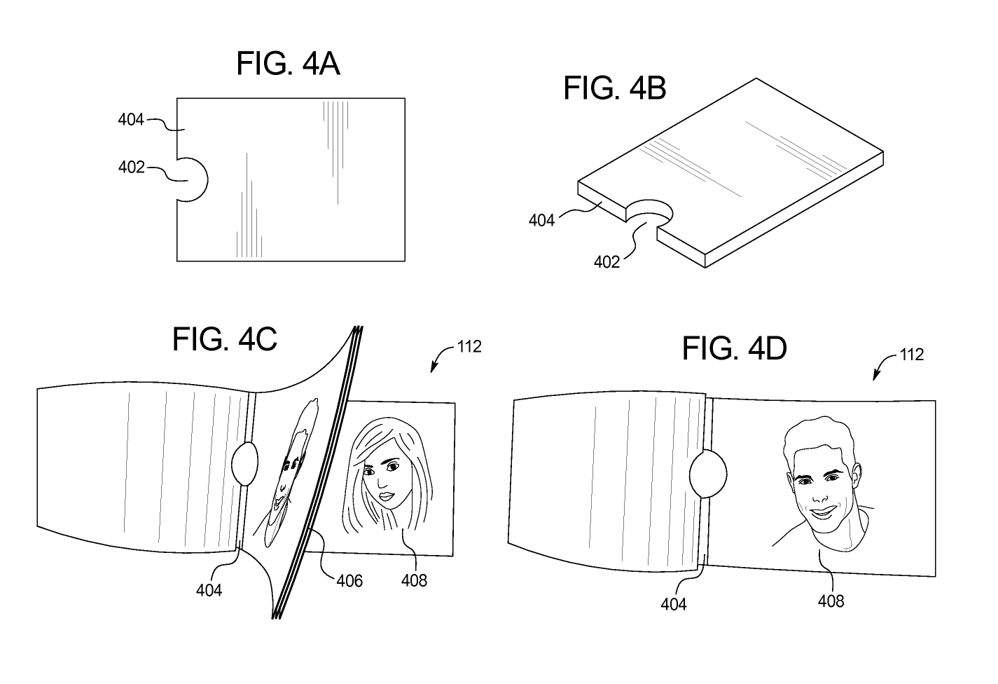

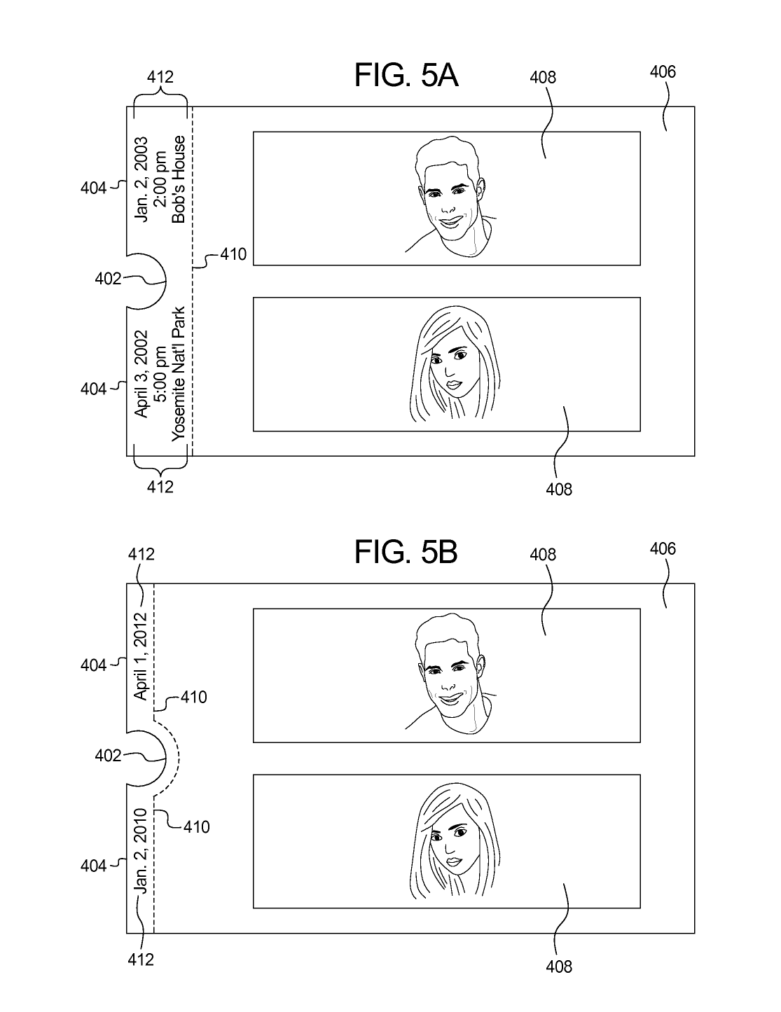

The flowchart of FIG. 2 at step 210 indicates that the vendor may print the uploaded digital images 408 to a photobook 112. In a preferred embodiment, the printed digital images 408 may be assembled in a photobook 112 including a plurality of pages 406 including a plurality of printed images 408. The photobook 112 also includes a bound edge 404 that binds an edge of each of the plurality of pages 406, wherein the bound edge 404 includes at least one recessed void along its length, wherein the recessed void increases the flexibility of the bound edge 404. In an example, the recessed void is a semicircle void 402 carved out of its bound edge 404 (see FIGS. 4A-B). In addition, the plurality of pages 406 may also include the recessed void along a length of the bound edge 404, as shown in FIGS. 5A-5B. Carving out a semicircle void 402 from the bound edge 404 of the photobook enables it to be shipped as bulk mail. Bulk mail may not be shipped with a stiff bound edge, but the semicircle void 402 makes the bound edge 404 flexible enough for the photobook 112 to be shopped as bulk mail under USPS regulations. It is contemplated that the recessed void shape carved from the bound edge 404 of the photobook 112 may be ovate, triangular, or any other shape suited to cause the bound edge 404 of the photobook 112 to be flexible enough to meet USPS bulk rate requirements.

In some embodiments, the photobook 112 may be assembled with a plurality of pages 406 having bound edges that are perforated for easy removal from the book. For example, as shown in FIG. 5A, the bound edge may include a perforation 410, wherein the perforation 410 extends parallel to the bound edge 404. Alternatively, the perforation 410 may extend parallel to the bound edge 404 and the semicircle void 402, as shown in FIG. 5B. The plurality of pages 406 may include a time stamp 412, wherein the time stamp 412 may include the time, date, and/or location associated with the photos opposite the perforation, as shown in FIGS. 5A-5B. Alternatively, the time stamp 412 may be on the same side of the perforation 410 as the printed image. The examples shown in FIGS. 5A and 5B show two photos 408 per page 406, in contrast to the single photo 408 per page 406 in other examples, simply to demonstrate that any number of photos 408 may be provided on any given page 406.

In other embodiments, tear-out ads and coupons may be inserted within the photobook 112 interspersed between the printed digital images 408. This makes it significantly more likely that the user will view the ads or coupons rather than throw them away as junk mail because the user is looking through a photobook 112 that the user cares about. Therefore, the user will not know to skip over the ads without viewing them as a user may in a bulk mailing that is nothing but advertisements. In a preferred embodiment, the ads may be randomly, or quasi-randomly, inserted between printed digital images 408 so that the user is unlikely to know whether the next page will be a photo or an ad. The ads may also be printed on pages bound into the photobook 112, wherein the pages with the advertisements include a perforation. In such example, a user may tear out the advertisements from the photobook 112 as the user goes through the book, essentially forcing the user to view the advertisements.

The flowchart of FIG. 2 at step 212 indicates that the vendor may ship the photobook 112 to the user via USPS bulk mail on a monthly basis. In some embodiments, the vendor may also ship copies of the photobook 112 to the previously selected recipients designated by the user. In other embodiments, the shipping interval may vary based on user preferences.

FIGS. 3A and 3B are a series of screenshots illustrating an example of a user interface to be used with the systems and methods described herein. Turning now to FIG. 3A, the screenshots show an example of a mechanism to manually add or remove digital images 408 previously uploaded to the remote server 106 and therefore queued for printing. Once the software application 102 of the present invention has been installed on the mobile device 104, a user may launch the software application 102 and select a “REVIEW” button from the mobile device, as shown at step 302. In response to the selection of the “REVIEW” button, the software application 102 may provide the user with an interface screen revealing thumbnail views of the uploaded digital images 408, as shown at step 304. The user may then repeatedly select a thumbnail image to cycle through symbols indicating the user's intended printing queue status for each digital image 408. For example, a red “X” may indicate that the image will either not be uploaded or will be removed from the printing queue. Alternatively, a green checkmark may indicate that a photo has been uploaded and will be printed. Finally, a green sash displaying the word “UPLOADED” across an image may confirm that the image has been both uploaded to the remote server 106 and placed in the printing queue.

Turning now to FIG. 3B, the software interface screenshots show an example of a mechanism to manually increase or decrease the intended quantity of each digital image 408 previously uploaded to the remote server 106 and queued for printing. Once the software application 102 of the present invention has been installed on the mobile device 104, a user may launch the application and select an “Information” button from the mobile device 104, as shown at step 306. Selecting the “Information” button may cause the software application 102 to provide the user with an interface subscreen, as shown at step 308 and having a selection tab labeled “Advanced Photo Selection Mode.” Selecting the “Advanced Photo Selection Mode” button may cause the software application 102 to provide the user with an interface screen revealing thumbnail views of the uploaded digital images 408, as shown at step 310. The user may then click a “+” or “−” symbol adjacent to each thumbnail image to increase or decrease, respectively, an intended quantity for each digital image 408 provided in the printing queue.

Turning now to FIGS. 4A-D, the images are exemplary of a photobook 112 provided in accordance with the present invention. FIGS. 4A and 4B are both images of the photobook 112 of the present invention captured at alternative angles intended to display the semicircle void 402 carved from the bound edge 404 of the photobook 112. FIGS. 4C and 4D are both images of the photobook 112 of the present invention laid open to display the flexibility of the bound edge 404 of the photobook 112 in compliance with USPS bulk mail requirements.

As described in more detail above, the unique structure of the photobook 112, particularly the void 402 in the bound edge 404 is important in reducing the fees for the delivery of the photobook 112 through the USPS. However, it is understood that other variations of the photobook 112 may be implement in the systems and methods described herein, including those without uniquely bound edges.

Throughout the description above, the flexible bound edge 404 is created by binding the edge of the photobook 112 and then removing a segment of the bound edge to create the flexible bound edge 404. It is contemplated that alternatives to this process may be employed, including removing a section of the edge prior to binding, binding disjointed segments of the edge, etc. The final structure and flexibility of the bound edge 404 are more important than the order of the steps or the specific steps required to create the finished product. It is understood that additional methods of production may be employed to create the unique flexible bound edge 404 taught herein.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A photobook comprising:
a plurality of pages including a plurality of printed images; and
a bound edge that binds an edge of each of the plurality of pages, wherein the bound edge includes at least one recessed void along its length, wherein the recessed void increases the flexibility of the bound edge.

2. The photobook of claim 1 wherein the recessed void is a semicircle void.

3. The photobook of claim 1 wherein the recessed void enables the photobook to qualify to be shipped as bulk mail under USPS regulations.

4. The photobook of claim 1 further comprising one or more pages including one or more advertisements interspersed between the plurality of pages.

5. The photobook of claim 1 wherein the each of the plurality of pages include a perforation extending parallel to the bound edge, wherein tearing along the perforation of one of the plurality of pages separates the page from the photobook.

6. The photobook of claim 5 wherein the plurality of pages include a time stamp located between the bound edge and the perforation.

7. A system for providing a photobook, the system comprising:
a mobile device comprising a software application and stored digital images;
a remote server in communication with the mobile device; and
a book binding machine in communication with the remote server,
wherein the software application is configured to:
access the stored digital images,
receive selected stored images, and
periodically send the selected stored images to the remote server,
wherein the book binding machine is configured to access the selected stored images from the remote server, and wherein the book binding machine produces a photobook of printed selected stored images on a plurality of pages,
wherein the photobook includes a bound edge that binds an edge of each of the plurality of pages, wherein the bound edge includes at least one recessed void along its length, wherein the recessed void increases the flexibility of the bound edge.

8. The system of claim 7 wherein the receiving selected stored images includes the software application periodically selecting images from a plurality of stored images within the mobile device.

9. The system of claim 7 wherein the receiving selected stored images includes receiving selecting images from a user via a user interface, wherein the selected stored images are selected from a plurality of stored images within the mobile device.

10. A method of providing a photobook, the method comprising:
accessing a plurality of digital images stored in a mobile device, wherein the mobile device is in communication with a remote server;
selecting a portion of the plurality of digital images; and
periodically transmitting the selected digital images to the remote server in communication with a book binding machine,
wherein the book binding machine is configured to print the selected digital images and bind the printed selected digital images in a photobook, wherein the photobook includes a bound edge including at least one recessed void along its length, wherein the recessed void increases the flexibility of the bound edge.

11. The method of claim 10 further comprising shipping the photobook using a bulk mail service.

12. A book binding system comprising:
a software application configured to access stored digital images within a mobile device, wherein the software application periodically selects a portion of the stored digital images for transmission to a book binding machine,
wherein the book binding machine prints and binds the selected stored digital images into a photobook, wherein the photobook includes a bound edge including at least one recessed void along its length, wherein the recessed void increases the flexibility of the bound edge.

13. A book binding system comprising:
a book binding machine configured to:
receive selected digital images;
print the selected digital images; and
bind the selected digital images into a photobook,
wherein the photobook includes a bound edge including at least one recessed void along its length, wherein the recessed void increases the flexibility of the bound edge.

14. The system of claim 13 wherein the recessed void is a semicircle void located approximately at the midpoint of the length of the bound edge.

15. The system of claim 13 wherein the recessed void enables the photobook to qualify to be shipped as bulk mail under USPS regulations.

16. A book binding method comprising:
receiving selected digital images;
printing the selected digital images; and
binding the selected digital images into a photobook,
wherein the photobook includes a bound edge including at least one recessed void along its length, wherein the recessed void increases the flexibility of the bound edge.

17. The system of claim 16 wherein the recessed void is a semicircle void located approximately at the midpoint of the length of the flexible bound edge.
The system of claim 16 wherein the recessed void enables the photobook to qualify to be shipped as bulk mail under USPS regulations.
